(19) United States
(12) Patent Application Publication
(10) Pub. No.: US 2025/0173895 A1
(43) Pub. Date: May 29, 2025

(54) LASER-CAMERA INTERACTIVE AND IMAGE PROCESSING-BASED DISPLACEMENT MEASUREMENT

(71) Applicants: KARADENIZ TEKNIK UNIVERSITESI TEKNOLOJI TRANSFERI UYGULAMA VE ARASTIRMA MERKEZI MUDURLUGU, TRABZON (TR); DYNAMIC ACADEMY YAZILIM INSAAT SANAYI TICARET LIMITED SIRKETI, Trabzon (TR)

(72) Inventors: FATIH YESEVI OKUR, Trabzon (TR); EBRU KALKAN OKUR, Trabzon (TR); AHMET CAN ALTUNISIK, Trabzon (TR)

(73) Assignees: KARADENIZ TEKNIK UNIVERSITESI TEKNOLOJI TRANSFERI UYGULAMA VE ARASTIRMA MERKEZI MUDURLUGU, TRABZON (TR); DYNAMIC ACADEMY YAZILIM INSAAT SANAYI TICARET LIMITED SIRKETI, TRABZON (TR)

(21) Appl. No.: 19/026,392

(22) Filed: Jan. 17, 2025

(30) Foreign Application Priority Data
Nov. 29, 2023 (TR) 2023/016105

(51) Int. Cl. G06T 7/73; H04N 23/56

(52) U.S. Cl. CPC G06T 7/74; H04N 23/56

(57) ABSTRACT

This invention relates to a system and method for measuring displacements occurring in all types of materials and structures under the influence of external loads. Through this invention, a laser-camera interactive and image processing-based displacement measurement method, as well as a measurement system for implementing this method, has been developed. A laser mounted at a fixed point projects a beam onto a black box placed at the measurement point, and the coordinates of the point where the laser beam strikes are determined using a camera mounted on this box, enabling the calculation of the displacement value.

### CROSS REFERENCE TO THE RELATED APPLICATIONS

This application claims priority based on Turkish patent application No. 2023/016105 filed on Nov. 29, 2023, the entire contents of which are hereby incorporated by reference.

### TECHNICAL FIELD

This invention relates to a system and method for measuring displacements occurring in all types of materials and structures under the influence of external loads.

### BACKGROUND

Displacement measurement sensors are electronic components that enable the measurement of the distance between two points. These sensors are categorized into two types based on their technology: contact and non-contact sensors. Contact sensors establish physical contact with the measured object, whereas non-contact sensors do not require any physical interaction with the object.

Contact sensors include types such as LVDT, string potentiometers, and slide potentiometers. These sensors provide measurement values based on voltage outputs that vary with distance. Since these types of sensors must be attached to a reference point on the object to be measured, they are not suitable for use in structures such as buildings, bridges, dams, factories, sports halls, large-span roofs, and historical structures.

Non-contact sensors include types such as eddy current sensors, laser distance meters, fiber optics, and cameras. These types of sensors are used in applications requiring high precision. However, as the distance between the object to be measured and the sensor increases, measurement accuracy decreases, making it challenging to use these sensors in structures requiring precise measurements. In recent years, camera-based displacement measurement studies have also been conducted. Displacement measurements can be performed by placing a marker on the object to be measured and using optical zoom with a camera. However, in these applications, accuracy also diminishes as the distance between the sensor and the object increases.

The cost of non-contact measurement sensors increases with their measurement precision.

The document WO2019215261A1 describes a measurement device and method used to measure the inclinations and irregularities of the surface of a light test stand. The device includes a laser, a projection element, and a camera, and it can move over the surface. The method determines inclinations and irregularities by utilizing the positional changes of the laser on the projection element.

The document WO9009560A1 explains the operating principle of a distance measurement device. The device uses a beam expander and a diffraction grating to expand and direct a light beam. Convergent rays are directed towards the target surface, where they are imaged and processed.

According to the document EP2613122A1, the displacement of the surface of a strip-shaped component is measured using a two-dimensional displacement sensor that includes first and second laser units, a camera, and an optical element.

The document EP1750085A2 describes a laser tracking interferometer that uses a laser beam to detect the displacement of a retroreflector. This system consists of a carrier, a displacement gauge, and a data processing apparatus.

In light of the prior art, there is a need to develop a sensor and an operating method capable of performing displacement measurements for a distant point that requires millimetric-level precision.

### SUMMARY

The objective of this invention is to develop a system and method for measuring displacements occurring in various materials and structures, such as engineering structures with load-bearing systems including buildings, bridges, dams, factories, sports halls, large-span roofs, and historical structures, under the influence of external loads such as snow, wind, temperature changes, earthquakes, and additional loads. The invention is particularly suitable for effective use in the long-term structural health monitoring of engineering structures. Furthermore, it is also applicable in many areas requiring precise displacement measurements, such as detecting permanent displacement movements caused by landslides.

In line with the objectives of the invention, a laser-camera interactive and image processing-based displacement measurement method, along with a measurement system for implementing this method, has been developed. A laser mounted at a fixed point projects a beam onto a black box positioned at the measurement point. Using a camera mounted on this box, the coordinates of the point where the laser beam strikes are determined, enabling the calculation of the displacement value.

The invention provides the following advantages:
The measurement accuracy of the displacement value is not affected by the distance between the measurement point and the reference point.
There is no requirement for highly advanced camera systems, allowing the integration of any camera system.
Due to its simple structure and lack of need for high-specification components, the system is cost-efficient.
Results with millimeter-level precision can be achieved.

### BRIEF DESCRIPTION OF THE DRAWINGS

The measurement system and method developed to achieve the objectives of this invention are explained with the accompanying figures.

FIG. 1A perspective view of a measurement system according to the invention.

FIG. 2A side sectional view of the viewing box and its associated components as shown in FIG. 1.

FIG. 3 An exploded view of the viewing box and its associated components as shown in FIG. 1.

FIG. 4A schematic representation of an initial image frame captured by the camera in the measurement system according to the invention.

FIG. 5A schematic representation of the i-th image frame captured by the camera in the measurement system according to the invention, with the reference trace shown in dashed lines.

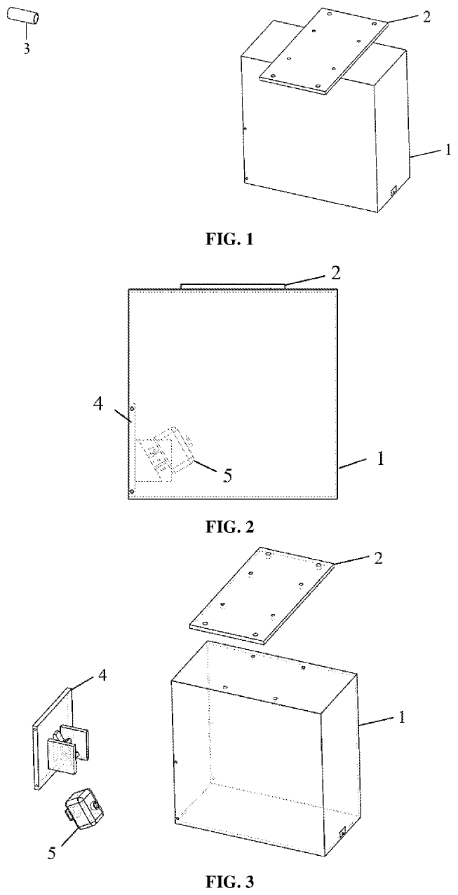

The components shown in the figures are numbered individually, and their corresponding descriptions are provided below:
1. Viewing Box
2. Mounting Plate
3. Laser
4. Camera Mounting Apparatus
5. Camera
6. Trace

### DETAILED DESCRIPTION OF THE EMBODIMENTS

To measure the displacement of a measurement point, the proposed measurement method involves using an image sensor, such as a camera (5), positioned at the measurement point and a light source, such as a laser (3), located at an external fixed point and directed towards the image sensor. The method fundamentally includes the following steps:
Generating a light beam directed at the image sensor using the light source.
Capturing an initial image frame with the image sensor at the first measurement time.
Determining the pixel coordinates of the trace (6) of the light beam on the initial image frame and storing these as the reference pixel coordinates.
Capturing an i-th image frame with the image sensor at a subsequent i-th measurement time.
Determining the pixel coordinates of the trace (6) of the light beam on the i-th image frame and assigning these as the i-th pixel coordinates.
Calculating the difference between the reference pixel coordinates and the i-th pixel coordinates.
Using the difference in pixel coordinates and the image sensor parameters to calculate the displacement of the measurement point at the i-th measurement time.

The image sensor parameters consist of elements that enable the mapping between the two-dimensional pixel coordinate system associated with the image sensor and the three-dimensional coordinate system related to physical objects. These parameters include the rotation matrix, translation vector, extrinsic matrix, intrinsic matrix, focal length, and curvature coefficient.

The measurement system of the invention, which facilitates the measurement of the displacement of a measurement point and implements the proposed measurement method, fundamentally consists of:
A Laser (3): Serves as the light source, producing a point light beam directed precisely at the measurement point.
A Viewing Box (1): Positioned at the measurement point, it allows the point light beam from the laser (3) to be received on a reflective surface. The viewing box (1) has an open front surface in the direction of the incoming light and closed surfaces on all other sides to prevent the measurement from being affected by ambient light.
A Camera (5): Serves as the image sensor, positioned inside the viewing box (1). It captures photographic data of the point light beam from the laser (3) for image processing.

The measurement system also includes a camera mounting apparatus (4), which ensures that the camera (5) is securely fixed inside the viewing box (1) in a way that prevents it from moving relative to the viewing box (1). Additionally, the system includes a mounting plate (2) that secures the viewing box (1) to the measurement point. The camera (5) is selected from portable types that can operate with various inputs such as USB, Ethernet, RS232, etc., and is mounted onto the camera mounting apparatus (4) before being placed inside the viewing box (1). The viewing box (1) is positioned at the region where the displacement motion is to be measured or at a fixed reference region using the mounting plate (2). The laser (3) generates a laser beam to create a point trace (6) within the viewing box (1). The laser (3) is placed either at a fixed reference region to project its beam into the viewing box (1) or at a region where relative displacement motion is to be measured. The point trace (6) created by the laser beam is captured in an image frame using the camera (5). The location of the point trace (6) on the viewing box (1) is determined in pixel coordinates. The first measurement taken in this manner is considered the reference measurement. For continuous monitoring, changes in the pixel position of the point trace (6) are recorded, and the displacement value is calculated based on the difference from the reference measurement.

Before starting measurements with the camera (5), it is necessary to perform camera calibration to determine the camera parameters (such as rotation matrix, translation vector, extrinsic matrix, intrinsic matrix, focal length, curvature coefficient, etc.). Camera calibration eliminates distortion effects. One of the most commonly used methods for camera calibration involves capturing multiple images of a target object with a patterned surface, such as a chessboard, to determine the camera parameters.

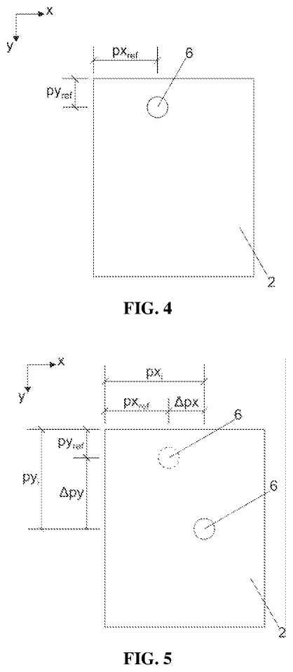

The visual representation of the image changes obtained from the photo frames using the camera (5) is shown in FIGS. 4 and 5. When the camera (5) focuses on the viewing box (1), it observes the point laser beam trace (6) on the dark inner surface of the viewing box (1). The purpose of the viewing box (1) is to reduce ambient light from the surroundings and provide a surface on which a measurable trace (6) is formed as a result of the laser beam reflection. To identify the pixel coordinates of the point trace (6) in the captured image, algorithms such as the Circle Hough Transform are used to determine its center. To calculate the displacement value, the initial pixel coordinates of the point trace (6) are taken as a reference, and the pixel differences are obtained by subtracting the new pixel coordinates from the reference in each subsequent photo frame (FIG. 5).

The displacement values of the measurement point are calculated using the formulas below, based on the coordinate system defined in FIGS. 4 and 5:

$$δ x = K Δ px , Δ px = {px}_{i} - {px}_{ref} \qquad ( 1 )$$

$$δ y = K Δ py , Δ py = {py}_{i} - {py}_{ref} \qquad ( 2 )$$

In this context, δx represents the displacement in the x-direction, while δy denotes the displacement in the y-direction. K refers to the displacement calibration coefficient, Δpx represents the pixel change in the x-direction and Δpy represents the pixel change in the y-direction. Additionally, pxᵢ and pyᵢ indicate the instantaneous pixel coordinates in the x and y directions, respectively, while px_{ref} and py_{ref} refer to the reference pixel coordinates in these directions. The x and y directions are preferably defined to correspond to horizontal and vertical displacements by positioning the viewing box (1) appropriately.

The displacement calibration coefficient K is determined by using the known dimensions of an object with real measurements, the known displacement values, and the pixel changes derived from these displacement values in Equation 1 or Equation 2.

1. A measurement method for determining a displacement of a measurement point, applied using an image sensor positioned at the measurement point with a displacement to be measured, and a light source positioned at an external fixed point and directed at the image sensor, comprising the steps of:
generating a light beam directed at the image sensor by the light source,
capturing an initial image frame with the image sensor at a first measurement time,
determining pixel coordinates of a light beam trace on the initial image frame and storing the pixel coordinates as reference pixel coordinates,
capturing an i-th image frame with the image sensor at a subsequent i-th measurement time,
determining the pixel coordinates of the light beam trace on the i-th image frame and assigning the pixel coordinates as i-th pixel coordinates,
calculating a difference between the reference pixel coordinates and the i-th pixel coordinates,
using a change in the pixel coordinates and parameters of the image sensor to calculate the displacement of the measurement point at the i-th measurement time, wherein displacement values of the measurement point are characterized as
$$δ x = K Δ px , Δ px = {px}_{i} - {px}_{ref} \qquad ( 1 )$$
$$δ y = K Δ py , Δ py = {py}_{i} - {py}_{ref} \qquad ( 2 )$$
wherein δx represents a displacement in an x-direction, δy represents a displacement in a y-direction, K represents a displacement calibration coefficient, Δpx represents a pixel change in the x-direction and Δpy represents a pixel change in the y-direction, pxᵢ and pyᵢ represent instantaneous pixel coordinates in the x direction and the y direction, respectively, and px_{ref} and py_{ref} represent reference pixel coordinates in the x direction and the y direction, respectively.

2. The measurement method as described in claim 1, wherein the displacement calibration coefficient K is determined by using known dimensions of an object with real measurements, known displacement values, and the pixel changes derived from the displacement values in Equation (1) or Equation (2).

3. The measurement method as described in claim 2, wherein the displacement values are determined by using the pixel changes derived from the displacement values in Equation (1) or Equation (2).

4. A measurement system for determining a displacement of a measurement point, comprising:
a laser configured to generate a point light beam directed precisely at the measurement point,
a viewing box positioned at the measurement point, wherein the viewing box allows the point light beam from the laser to be received on a reflective surface, and the viewing box has an open front surface in a direction of an incoming light and all other surfaces closed to prevent the measurement system from being affected by ambient light,
a camera positioned inside the viewing box, configured to capture photographic data of the point light beam from the laser for image processing.

5. The measurement system as described in claim 4, further comprising a camera mounting apparatus configured to secure the camera inside the viewing box, thereby preventing the camera from moving relative to the viewing box.

6. The measurement system as described in claim 4, further comprising a mounting plate configured to secure the viewing box to the measurement point.
